(19) United States
(12) Patent Application Publication
(10) Pub. No.: US 2012/0018474 A1
(43) Pub. Date: Jan. 26, 2012

(54) ROOF BOX

(76) Inventors: Joakim Lindberg, Stalldalen (SE); Jan Lindberg, Orebro (SE)

(21) Appl. No.: 13/144,708

(22) PCT Filed: Jan. 18, 2010
(86) PCT No.: PCT/SE10/50040

§ 371 Date: Oct. 3, 2011

(30) Foreign Application Priority Data
Jan. 16, 2009 (SE) 0950011-7

(51) Int. Cl. B60R 9/055; G09F 13/00; G09F 13/22; B60Q 1/00

(52) U.S. Cl. 224/328; 362/459; 40/541; 40/544

(57) ABSTRACT

The present invention relates to a roof box comprising a bottom member (4) including a bottom section (32 and side sections (33) extending upward from said bottom section, where said bottom member is arranged for mounting said roof box on a roof of a vehicle (28), a top member (1) that is movable in relation to said bottom member between an open and a closed position, where said top member includes a top section (30) and side sections (31) extending downward from said top section, where the top member and the bottom member in closed position form a storage space for storing objects inside the roof box. At least one of said side sections (33) of the bottom member (4) and/or the top member (1) include an outer shell (44, 1) provided with a transparent area (34). Further, the invention relates to use of an electroluminescent plate (10) as a shell with integrated light source for a roof box.

### TECHNICAL AREA

Roof box comprising a bottom member including a bottom section and side sections extending upward from said bottom section, where said bottom member is arranged for mounting said roof box on a roof of a vehicle, a top member that is movable in relation to said bottom member between an open and a closed position, where said top member includes a top section and side sections extending downward from said top section, where the top member and the bottom member in closed position form a storage space for storing objects inside the roof box. Further, the invention also relates to use of an electroluminescent plate as a shell with integrated light source for a roof box of the invention.

### BACKGROUND ART

In professional transportation of goods, tools, various types of equipment and implements on commercial vehicles, roof boxes are often used. Laws and ordinances require among other things within maintenance of the road network, for example, that vehicles shall be equipped with cruiser lights and visible identifications as to which vehicle or enterprise performs the piece of work. Some commercial vehicles additionally are equipped with spotlights that can be maneuvered from within the coupe of the vehicle. These lamps and sometimes also signs are as a rule mounted on a stand on the vehicle roof. All in all, this often involves that the vehicle roof is cluttered up with rails and holders for this equipment, which makes it difficult to load and unload what is transported in the roof box. Further, signs and lamps are exposed to wear by action of dirt and wind and weather.

A flexible electroluminescent plate is previously known from US2007/0113440.

A roof box having a double-wall cover is previously known from US2008/0017679.

### SUMMARY OF THE INVENTION

It is an object of the present invention to eliminate or at least minimize some of the above mentioned problems, which is achieved in that said top member includes a transparent area, which constitutes an integrated part of an outer shell in the top member, and a light source for illuminating the transparent area, where said light source is a thin and preferably electroluminescent light source stretching out along the transparent area.

Owing to the invention, it is possible to provide a roof box, where the covering shell may be wholly or partly transparent in order to make various messages visible also during dark circumstances by means of light and when required provide cruiser lights and extra lights for increased road safety and visibility adjacent the transparent area.

In accordance with further aspects of the invention, it will be possible to offer a roof box where one or more messages are illuminated by light from the inside of the roof box. These messages may be applied on the roof box by a plurality of different printing techniques. The shape of the roof box also offers a possibility of providing cruiser lights for different entrepreneurs and emergency circumstances, where required, in a sheltered place inside the roof box. There is also a possibility of providing extra lights for creating good visibility for vehicle drivers where required by such conditions. That the entire arrangement is enclosed in a closed space must be regarded as great advantages in view of dirt, snow and water and especially damage to and stealth of components included in the arrangement.

### BRIEF DESCRIPTION OF THE FIGURES

In the following, the invention will be described in more detail with reference to the appended drawings, where:

FIGS. 1a-e schematically show how a roof box according to one embodiment of the invention is constructed,

FIGS. 2a-d and 3a-c principally show the parts included in the roof box top member according to various embodiments for applying a message on the top member,

FIGS. 4a-d schematically show various types of light sources provided on the top member,

FIGS. 5a-d show how the bottom member is constructed, and

FIG. 6 shows a side view of a roof box of the invention according to a preferred embodiment mounted on a vehicle.

### DETAILED DESCRIPTION OF THE FIGURES

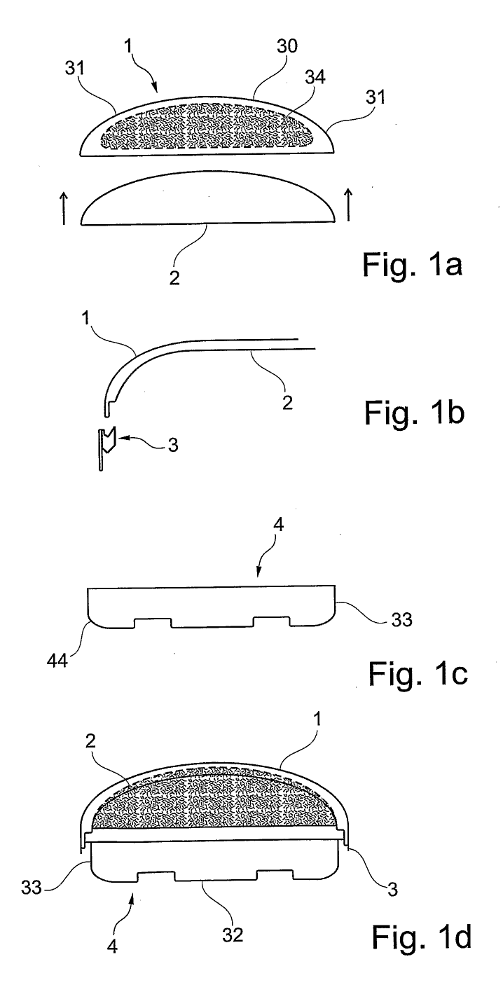

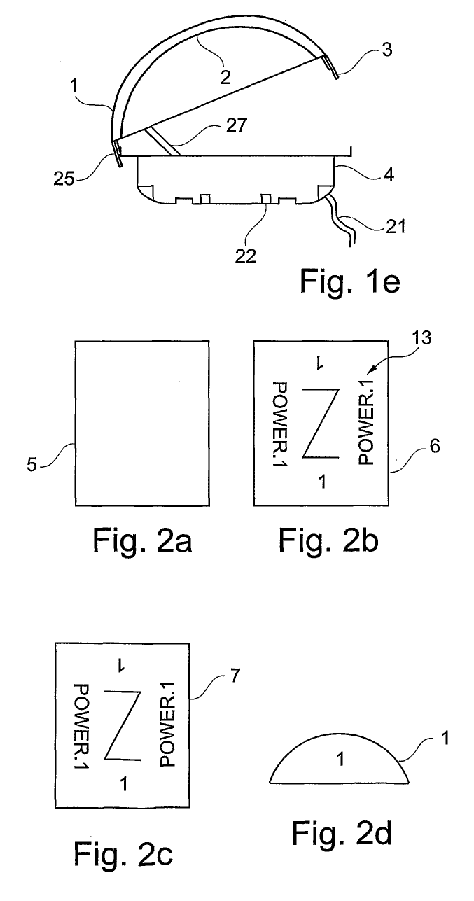

FIGS. 1a-e schematically describe how a roof box according to a possible embodiment of the invention is constructed. The roof box comprises a top member 1, which includes an essentially horizontally extending top section 30 and side sections 31 extending downward from said top section, vide FIG. 1a. Further, the roof box comprises a bottom member 4 including a bottom section 32 and side sections 33 extending upward from said bottom section, vide FIG. 1c. In a manner known to a person skilled in the art, the bottom member is provided with fastening devices and suchlike devices for mounting said roof box on a roof of a vehicle, not shown. The top member and the bottom member form in closed condition a storage space for storing objects, vide FIG. 1d, which shows the roof box in a view from behind. As is known per se, the top member is movable in relation to said bottom member between an open and a closed position, vide FIG. 1e, which shows the roof box in a front view and in an open position. A gas spring 27 maintains the top member in an open position. According to the inventive concept, at least a side section of the top member and/or the bottom member includes an outer shell 1, 44, which is provided with a transparent area adjacent which a light source is provided. In FIG. 1a, there is shown a transparent area 34 in the top member. Further, there is shown an upper inner shell 2, which may be joined to the upper outer shell to provide a double-wall cover in the top member, if it is desired. Between the two shells, a narrow gap-like inner space (35) is formed when they are joined to each other. In FIG. 1b, there is shown in cross-section a detail of a side section of a double-wall cover, where the upper outer shell 1 is joined to the upper inner shell 2 along their respective peripheral edges. Further, there is shown a cross-section of a sealing strip 3 intended to be mounted along the bottom edge of the top member, where incidentally the two shells are joined in some way known to a person skilled in the art, e.g. by pressing the peripheral edges of the two shells together during the forming thereof, so that they fuse together.

Unless something else is stated in the description, ‘underside’ of the shell parts that form the top member means the side that in ready-shaped state will face inward, toward the storage space of the roof box. ‘Upper side’ of the top member shell parts means the side that will face outward, in a direction away from the roof box storage space.

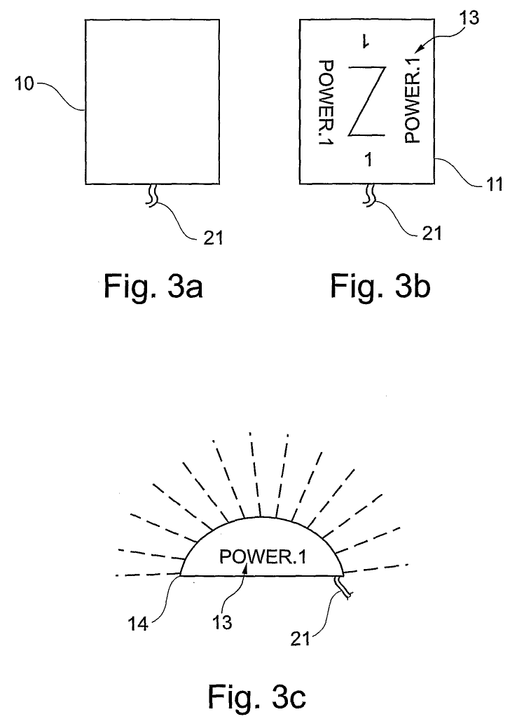

In FIG. 2a there is shown a plate of thermoplastic resin 5, which in this case is completely transparent. On the underside (which in ready-shaped state forms the inside of the upper outer shell) of this plate a preprinted film 6 with screen print, for example, is applied, and the result is the composite plate 7, where a message 13 on the film (1 and POWER.1) is readily visible through the transparent plate. Thereafter, the plate is exposed to a thermoforming operation where the plate is heated and pressed in a press shaping tool to desired shape, here the upper outer shell 1, which is shown schematically in FIG. 2d. It is also possible to screen-print on the plate of thermoplastic resin directly.

According to the inventive concept, it should be possible to thermoform said outer and inner shells by some of the processes for thermoforming available on the market. Further, in accordance with the inventive concept, it should be possible to apply possible messages on the shells prior to this forming operation in order to get a rational and cost efficient production. For this reason, in a preferred embodiment a transparent plate of thermoplastic resin constitutes said outer shell, whereby said transparent area 34 will constitute an integrated part of the outer shell. Thereby, possible problems with leaking joints between the transparent material and the proper cover are avoided, and it is realized that this is a definite advantage in view of light sources and possible messages that are arranged within the transparent areas, which thereby will be protected against wear.

In FIG. 3a there is shown a second embodiment of the upper outer shell of the top member of the roof box which is provided with some form of light source that illuminates the outer shell from its inside. Preferably, said light source is a thin and preferably electroluminescent light source spreading out along the transparent area (34).

In accordance with a first version of the embodiment, the upper outer shell is formed from a transparent plate of electroluminescent material 10. One example of such a material is marketed under the tradename Briflex. by Metalor Technologies. According to a second version of this embodiment, application of a message may be carried out in accordance with the method with inked electroluminescent pastes that can be screen-printed on a laminate of thermoplastic resin 13 as described by Metalor Technologies, which is indicated in FIG. 3b. According to a third version of this embodiment, a light emitting film 12, i.e. a film emitting light on supply of current thereto, is applied against the underside of the upper outer shell. In this embodiment, the message 13 may either be applied to the underside of the upper outer shell or to the upper side of the light-emitting film. The result after thermoforming will be a top member of the roof box that can be illuminated from within, which is shown in FIG. 3c, where a possible message is clearly evident also in the evening. Current is supplied through a power cord 21.

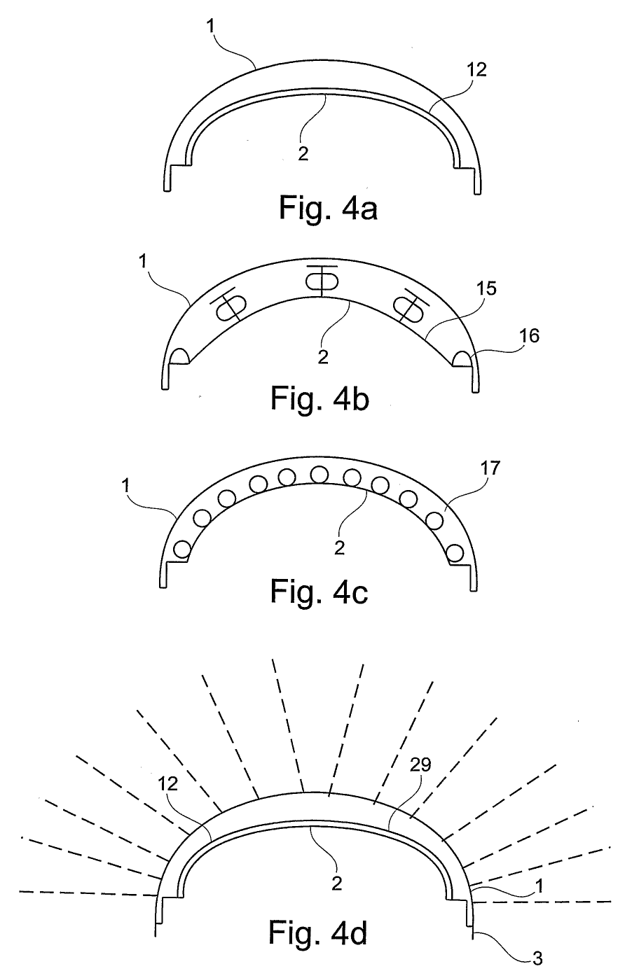

In FIGS. 4a-d, some different ways of illuminating the upper outer shell of the top member are shown. In FIGS. 4a-c, embodiments are intended where the underside of the upper outer shell is provided with the message to be shown. In FIG. 4a, a light-emitting film 12 is shown mounted on the upper side of the upper inner shell 2. In FIG. 4b, there is schematically shown a strip 15 with light-emitting diodes 16 mounted on the upper side of the upper inner shell 2. An additional way of illuminating the upper outer shell is to mount an incandescent filament (light wire) 17 (http://www.thinlight.se/produkter/ljustrad/) on the upper side of the upper inner shell 2, which is illustrated in FIG. 4c.

An additional solution of illuminating the upper outer shell may be to screen-print with colored or uncolored electroluminescent pastes 29 or similar media on the upper surface of the upper inner shell 2, i.e. use the technique described by Metalor Technologies. The result will be an upper double-wall cover comprising an upper outer shell 1 and an upper inner shell 2, which together form an intermediate inner space (35), where anyone of the light sources above is contained. It is realized that it is advantageous at arrange the light sources in the inner space between the shells. On one hand, they are protected against damage by wind and weather and by loaded goods in the storage space of the roof box, and on the other hand persons are protected from getting in contact with live parts.

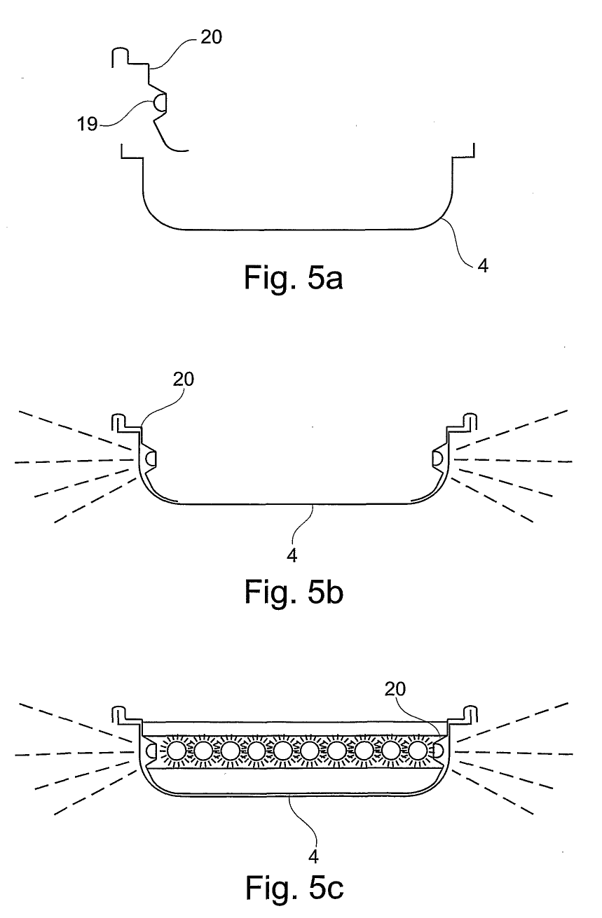

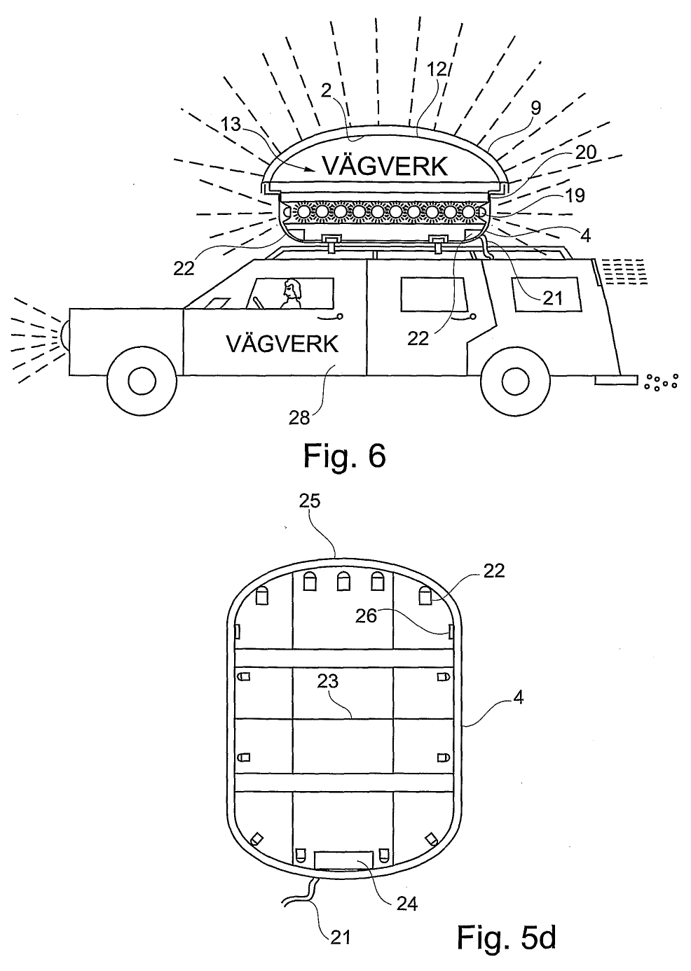

FIG. 5a shows in profile a light source 19, e.g. a cruiser light or extra light but also a light source for illumination of messages in intended, which is applied on a specially shaped strip 20 that is mounted in the bottom member 4, which is shown in FIG. 5b. In FIG. 5c, the bottom member of the roof box is shown in a frontal view. The bottom member 4 here contains an arrangement of extra lights 22, which are located well protected inside a transparent area in the forward side section of the bottom member. In FIG. 5d, the interior of the bottom member is shown in a top view. In the figure, a number of partitions 23 is indicated, suitably demountable and combinable in various ways for dividing the interior into storage compartments of suitable size to the user by mounting in grooves in the walls and bottom of the bottom member. The bottom member 4 also comprises hinges 25 or other suitable connecting devices, by means of which the top member 1 and the bottom member 4 may be united, and holders 26 for gas springs or the like for opening and stabilization of the top member in its open position. In the bottom member 4, there is also controlling, regulating and electronic equipment 24 mounted, the purpose of which is to control the various lighting functions, such as flashing frequency for cruiser lights, switching of various extra lights in various positions, and transformation of the power to the selected light source for illuminating the upper outer shell of the top member. In a preferred case, the controlling, regulating and electronic equipment 24 should control also start and stop of the power to the light source, tentatively in that electronic equipment via some kind of signal (sound, electric, or vibrations) gives an input to controlling, regulating and electronic equipment 24 to start or stop the current to the light source. Power for driving the controlling, regulating and electronic equipment 24 comes from the electric system of the vehicle via an electricity cable 21.

In FIG. 6, a roof box of the invention is shown mounted on a commercial vehicle 28. In the figure, there is shown how the upper outer shell 1 is illuminated from within, e.g. via a light emitting film 12 applied on the upper inner shell 2. A message 13 (VÄGVERK, i.e. National Road Administration) is clearly visible against a luminous background. The message may be in colored material of various grades of light transmission (transparency and translucency). A strip 20 mounted on the inside of the side piece of the bottom member, inside of a transparent area, includes light sources 19 that emit a flashing cruiser light.

The invention also relates to the use of an electroluminescent plate as light source in a roof box of the invention.

The invention is not restricted by what is described above, but may be varied within the scope of the appended claims. As an example, it is realized that the roof box may be tailored with various light sources, cruiser lights, etc. to suit different light requirements for different conditions and markets. E.g. the top member may be equipped with cruiser lights and extra lights of the embodiment described for the bottom member, and logotypes etc. may be provided in the bottom member and be illuminated. Subareas of the roof box may be illuminated by controlling which light sources are lit. If light sources of different colors, e.g. diodes, are used, they may of course be arranged to create the message that is desired to display. This may be used separately or in combination with printed matter.

Further, it is possible to illuminate the roof box in accordance with a technique that is known from edge illuminated signs, i.e. where light sources (diodes) are located along the edge of a plate and the light that radiates into the interior of the plate is spread further from the edge by reflection against the upper side and underside to finally radiate through the plate front, whereby the plate in this way will be illuminated. The light sources (diodes) may be located adjacent the edge of the lower member of the roof box, tentatively contained in a protective strip, against which the roof box top member abuts in closed condition. In this way, power supply can easily be arranged in the bottom member in accordance with what has been described earlier. Of course, it is also possible to let the light sources be located along the edge of the top member, also here contained in a strip that protects electric connections, switches, etc., and protects the diodes against shocks. In that the light is spread out efficiently within the plate, a uniform illumination of the messages that are provided on the plate is obtained, either on its inside or its outside. In conformity with what is described earlier, the message is applied preferably before the actual forming of the plate takes place, i.e. when the plate by some plastics forming operation is given its shape as top member of the roof box. Evidently, in this embodiment the inner shell may possibly be dispensed with. This embodiment may possibly be the subject of a divisional application.

The transparent area can be made of various size, according to need, and transparent areas may be shielded by a film that does not transmit light, or a print when need arises, and shielded transparent areas are opened up. The transparency of the print may be controlled through the screen density of the print. Messages can be changed easily by changing the printed film. It is also possible to arrange the top member so that the transparent outer shell, in case the message is applied thereon, will be exchangeable, in order to quickly change message in this way on a roof box that is unchanged in other respects. Of course, it is possible to apply messages on the outer side of the upper outer shell in order not having to demount a double-wall top member, but it is realized that this will cause increased wear of the message. An advantage of placing the print on the inside is that, if the print is made on a film, a less expensive film may be used, not weatherproof, UV proof, etc. Similarly, a less expensive print may be used. Naturally, other light sources than those mentioned above and known by the person skilled in the art may be used. Of course, it is possible to provide the light source in the top member on the inside of the outer shell and to illuminate a message located on the inner shell, which thereby would be illuminated and well visible through the transparent area. Subareas of the top member or the bottom member may be made double-walled when required. If required, the inner shell can be made easily interchangeable, e.g. a plate that is placed in some kind of holder or groove for easy change of message, for example.

The possibility of collecting in the proposed manner and in one single unit both transport facilities of less heavy form and cruiser lights and illuminated surfaces for messages and extra powerful light conditions where required, e.g. when guarding various objects and search for road damages and injured animals, make the proposed roof box both easy to handle, efficient and cost-saving. The possibility of adding or removing various parts in the arrangement, when necessary, has to be regarded as a great advantage. For the initiated person, the possibility of partitioning the storage space of the roof box into larger or smaller compartments will be seen as great advantages.

Also the easy change of a message and adaption of the roof box to different light requirements at different conditions and in different markets must also be regarded as very advantageous.

1-16. (canceled)

17. Roof box comprising:
a bottom member including a bottom section and side sections extending upward from said bottom section, where said bottom member is constructed and arranged for mounting said roof box on a roof of a vehicle; and
a top member that is movable in relation to said bottom member between an open and a closed position, where said top member includes a top section and side sections extending downward from said top section, where the top member and the bottom member in closed position form a storage space for storing objects inside the roof box, wherein said top member includes a transparent area, which constitutes an integrated part of an outer shell in the top member, and a light source for illuminating the transparent area, where said light source is a thin light source stretching out along the transparent area.

18. The roof box according to claim 17, wherein the transparent area includes said side sections of the top member.

19. The roof box according to claim 17, wherein said outer shell includes a transparent plate of thermoplastic resin, which essentially constitutes said side sections and said top section.

20. The roof box according to claim 17, wherein the top member includes an inner shell which is located adjacent to at least the transparent area in the top member, where said inner shell is adapted in shape to the outer shell and joined thereto, so that the top member at least in the portion of the transparent area will form a double-wall cover having an internal space between the two shells, in which the light source is contained.

21. The roof box according to claim 17, wherein said light source is located on the inner side of the outer shell.

22. The roof box according to claim 20, wherein said light source is located on the outer side of the inner shell.

23. The roof box according to claim 17, wherein said light source is arranged to illuminate part of the transparent area.

24. The roof box according to claim 17, further comprising a plurality of transparent areas and a plurality of light sources associated thereto, which can be lighted separately.

25. The roof box according to claim 17, wherein adjacent to the transparent area there is provided a message which can transmit light.

26. The roof box according to claim 17, wherein said light source is an electroluminescent film or paste.

27. The roof box according to claim 26, wherein said electroluminescent film is provided with said message which at electrification will be lit and visible through said transparent area.

28. The roof box according to claim 17, wherein said light source includes at least one light emitting diode behind the transparent area in the outer shell.

29. The roof box according to claim 17, wherein said light source includes an incandescent filament behind the transparent area in the outer shell.

30. The roof box according to claim 17, wherein said outer shell includes an electroluminescent plate, which constitutes said side sections and said top section and said light source.

31. The roof box according to claim 17, wherein the bottom member includes a transparent area and a light source provided adjacent this area.

32. The roof box according to claim 17, wherein the transparent area includes said side sections of the top member and the top section.

33. A method of using an electroluminescent plate as a shell having an integrated light source for a roof box, wherein the roof box comprises:
a bottom member including a bottom section and side sections extending upward from said bottom section, where said bottom member is constructed and arranged for mounting said roof box on a roof of a vehicle; and
a top member that is movable in relation to said bottom member between an open and a closed position, where said top member includes a top section and side sections extending downward from said top section, where the top member and the bottom member in closed position form a storage space for storing objects inside the roof box, wherein said top member includes a transparent area, which constitutes an integrated part of an outer shell in the top member, and a light source for illuminating the transparent area, where said light source is a thin light source stretching out along the transparent area.

34. The method according to claim 33, wherein said light source is an electroluminescent film or paste.

35. The method according to claim 34, wherein said electroluminescent film is provided with a message which at electrification will be lit and visible through said transparent area.

36. Roof box comprising:
a bottom member including a bottom section and side sections extending upward from said bottom section, where said bottom member is constructed and arranged for mounting said roof box on a roof of a vehicle; and
a top member that is movable in relation to said bottom member between an open and a closed position, where said top member includes a top section and side sections extending downward from said top section, where the top member and the bottom member in closed position form a storage space for storing objects inside the roof box, wherein said top member includes a transparent area, which constitutes an integrated part of an outer shell in the top member, and a light source for illuminating the transparent area, where said light source is a thin electroluminescent light source stretching out along the transparent area.
